(19) United States
(12) Patent Application Publication
(10) Pub. No.: US 2015/0000302 A1
(43) Pub. Date: Jan. 1, 2015

(54) POWER PLANT COMPRISING A CONDENSED WATER RECOVERY DEVICE

(71) Applicant: NUOVO PIGNONE S.p.A, Florence (IL)

(72) Inventors: Fernando Roberto Biagi, Florence (IT); Marco Santini, Florence (IT); Giorgio Marchetti, Florence (IT)

(73) Assignee: NUOVO PIGNONE S.p.A., Florence (IT)

(21) Appl. No.: 14/368,058

(22) PCT Filed: Dec. 19, 2012
(86) PCT No.: PCT/EP2012/076111

§ 371 Date: Jun. 23, 2014

(30) Foreign Application Priority Data
Dec. 23, 2011 (IT) CO2011A00073

(51) Int. Cl. F02C 7/143; F02C 7/18

(52) U.S. Cl. CPC F02C 7/143; F02C 7/18
USPC 60/783; 60/728

(57) ABSTRACT

A power plant including a thermal machine, an inlet duct for delivering a combustive first fluid in said thermal machine, a ventilation circuit for delivering a cooling second fluid to said thermal machine, the first and/or the second fluid including water therein, and a water recovery device connected with the inlet duct and/or the ventilation circuit for condensing and collecting said water from the first and/or the second fluid, the water recovery device being associated with at least one heat exchanger thermally connected with the inlet duct and/or the ventilation circuit for cooling said first and/or said second fluid beyond the dew point thereof, the water recovery device further including connecting means for delivering the water condensed from the first and/or the second fluid to a water using device.

### BACKGROUND

1. Technical Field

The present invention relates to condensed water recovery devices, particularly, but not exclusively, for power plants including one or more thermal machines which in operation need to be supplied with air for combustion and/or ventilation purposes. Further, the present invention relates to a method for improving the overall efficiency in a power plant of the above mentioned type.

2. Background Art

A power plant for the production of electric or mechanical energy may include thermal machines, e.g. internal or external combustion engines like gas turbine engines or reciprocating engines or others.

Power plants of the above mentioned type normally includes an air inlet for providing combustive air inside the thermal machines of the power plant and an air ventilation circuit for providing cooling air on the outer surfaces of the same thermal machines. Such power plants are frequently needed to perform in hot environment or season and, particularly, they may be requested to provide peak power on the hottest hours of each day or on specific seasons, i.e. summer. When the power plant includes a gas turbine, unfortunately, as the inlet air temperature to a power plant goes up, the power that the turbine can generate goes down. This has driven the need for inlet-chilling systems including one or more heat exchangers installed at the air inlet, particularly within an air filter device, of the power plant.

Traditionally, there have been three options available for cooling down such heat exchangers: mechanical or evaporative or absorptive. Mechanical cooling uses mechanical compression to reduce the inlet air temperature to optimize the output of the thermal machine. Evaporative cooling sprays water into the turbine inlet air stream where it evaporates, cooling the air. Absorption cooling uses a source of heat, normally extracted from the exhaust of the thermal machine, to provide the energy needed to drive the cooling process.

In all the above cases, the cooling process produces condensed water downstream the heat exchangers. Such water is normally considered as an industrial waste and is therefore discharged in the waste liquid treatment plant.

Alternatively, the condensed water which is produced by the cooling process is recovered and recycled for further industrial use in the power plant. For example, in a power plant including a gas turbine, it is known from U.S. Pat. No. 5,390,505 to use such water, which is essentially demineralised water, in closed cycle, by injecting it into combustion zones of the gas turbine, in order to achieve power augmentation, fuel saving and nitrogen oxide (NOx) abatement. The above solution permits to increase the efficiency of the gas turbine but shows also some inconveniences. In fact, adding in the power plant a circuit for the introduction of the condensed water in the gas turbine may result in an increase of corrosion damages and thermal stresses in the hot section of the gas turbine and therefore in an increase of maintenance interventions, which imply stopping the power plant. Consequently the overall availability and reliability of the power plant would be reduced.

Inserting a water recovery device at the air inlet of the power plant normally results in a large production of condensed water. In some cases, when a lower amount of condensed of water is requested, (for example 0.5-3 m³/h) such solution may not be convenient and it would be desirable to derive another source of condensed water within the power plant.

### SUMMARY

An object of the present invention is to provide a power plant comprising a condensed water recovery device which allows recovering water from humid air flowing in the power plant, thus optimizing the overall efficiency and minimizing water waste.

According to a first embodiment, the present invention accomplish the object by providing a power plant comprising a thermal machine, an inlet duct for delivering a combustive first fluid in said thermal machine and a ventilation circuit for delivering a cooling second fluid to said thermal machine, the first and/or the second fluid including water therein; wherein the power plant further includes a water recovery device connected with the inlet duct and/or the ventilation circuit for condensing and collecting water from the first and/or the second fluid, the water recovery device being associated with at least one heat exchanger thermally connected with the inlet duct and/or the ventilation circuit for cooling said first and/or said second fluid beyond the dew point thereof, the water recovery device further including connecting means for delivering the water condensed from the first and/or the second fluid to a water using device.

According to a further feature of the first embodiment, the water using device is of the open-cycle type.

According to a further feature of the first embodiment, the water using device includes heating means for producing steam from the water separated and collected by the water recovery device and a steam expander for producing energy from said steam.

By providing a device for water recovery from the first combustive fluid or from the second ventilation fluid or from both the first and the second fluids, the present invention permits to conveniently generate the requested flow of recovered water, according to the needs of the power plant. If a large amount of recovered water is requested, the water recovery device is connected with the inlet duct and, optionally, with the ventilation circuit. If a reduced amount of recovered water is needed by the power plant, the water recovery device is connected only with the ventilation circuit. In the latter case, the needed amount of water can be obtained, in an existing power plant, with simpler and less costly modifications than those required to connect the inlet duct to the water recovery device.

The present invention allows optimizing the overall efficiency a power plant including a recovered water using device, particularly when the water using device is of the open-cycle type, for example a device including heating mean, like a boiler, for producing steam and a steam expander for producing energy from such steam. The cold source for the cooling power to be transferred to the heat exchangers of the water recovery device of the present invention can be of any type: mechanical, evaporative or absorptive.

A further object of the present invention is to develop a method for improving efficiency in a power plant including a thermal machine.

According to a second embodiment, the present invention accomplishes this further object by providing a method comprising the steps of thermally connecting at least one heat exchanger with an inlet duct of the thermal machine and/or the ventilation circuit of the thermal machine; operating the heat exchanger to cool a first fluid flowing in the inlet duct and/or a second fluid flowing in the ventilation circuit, the first and/or the second fluid including water therein, bringing said first and/or said second fluid beyond the dew point thereof in order to condensate the water therein, collecting the water condensed from the first and/or the second fluid, using the condensed water to improve the efficiency of the power plant.

According to a further feature of the second embodiment, the step of using the condensed water consists in delivering the condensed water to a combined cycle power unit and/or to a water treatment unit for producing drinkable water and/or to heating means for producing steam.

The same advantages described above with reference to the first embodiment of the present invention are accomplished by the second embodiment.

### BRIEF DESCRIPTION OF THE DRAWINGS

Other object feature and advantages of the present invention will become evident from the following description of the embodiments of the invention taken in conjunction with the following drawings, wherein:

FIG. 1 is a general schematic view of a power plant according to present invention;

FIG. 2 is a schematic view of a variant of the power plant in FIG. 1;

FIG. 3 is a more detailed schematic view of the variant in FIG. 2;

FIG. 4 is a schematic view of a further variant of the power plant in FIG. 1;

FIG. 5 is a schematic view of a further variant of the power plant in FIG. 1;

FIG. 6 is a flow chart diagram of a method for improving efficiency in a power plant according to the present invention.

### DETAILED DESCRIPTION

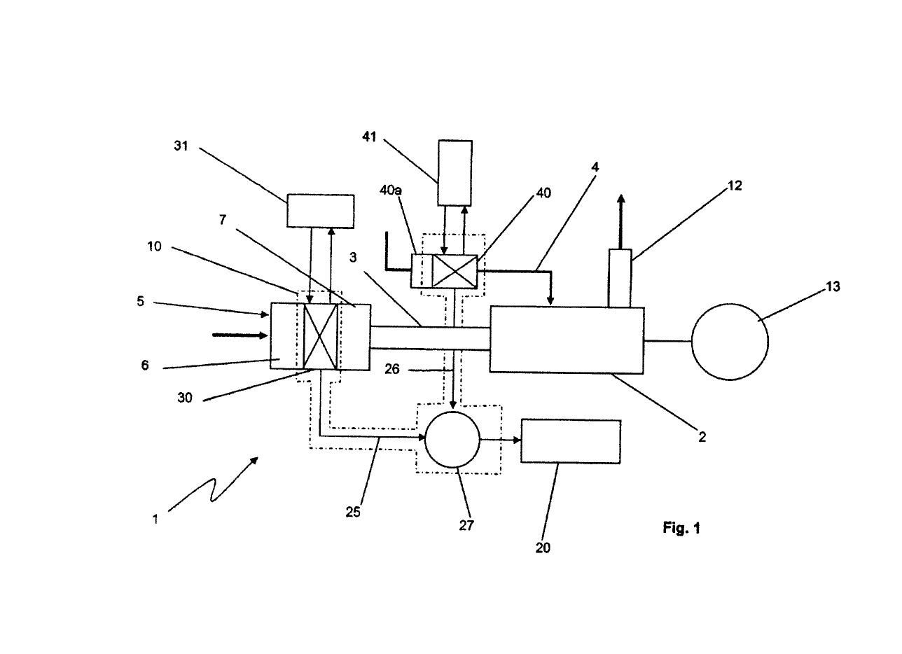

With reference to the embodiment FIGS. 1-5, a power plant 1 comprises a thermal machine 2, an inlet duct 3 for delivering a combustive first fluid in the thermal machine 2 and a ventilation circuit 4 for delivering a cooling second fluid to the thermal machine 2, the first and/or the second fluid including water therein. Typically, the first and the second fluid is humid air. When the thermal machine 2 is a gas turbine, the flow rate of the second fluid in the ventilation circuit is lower than the flow rate of the first fluid in the inlet duct. For a different type of the thermal machine 2, for example a reciprocating combustion engine, the flow rate of the second fluid in the ventilation circuit 4 may be greater than the flow rate of the first fluid in the inlet duct 3.

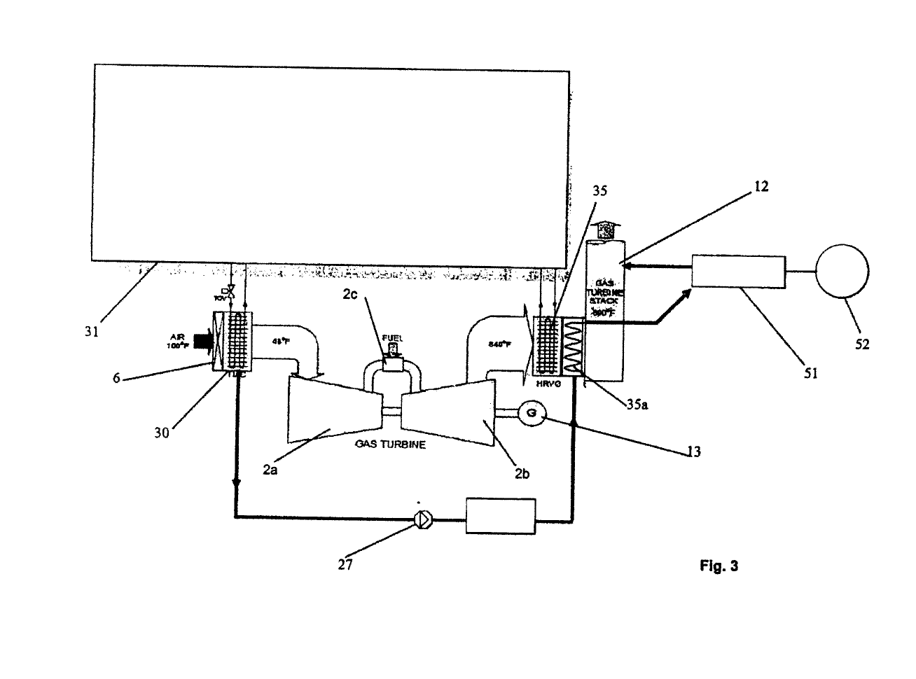

The thermal machine 2 can be of various types, all requiring to be supplied with a combustive first fluid and a ventilation circuit 4. For example, in known embodiments of the power plant 1, the thermal machine 2 is a reciprocating engine. In the embodiment of the power plant 1 shown in FIG. 3, the thermal machine 2 is a gas turbine engine including an upstream air compressor 2a, a downstream turbine 2b and a combustor 2c between them. In embodiments in FIGS. 1-4, the thermal machine 2 includes an exhaust stack 12 and is connected with an electric power generator 13.

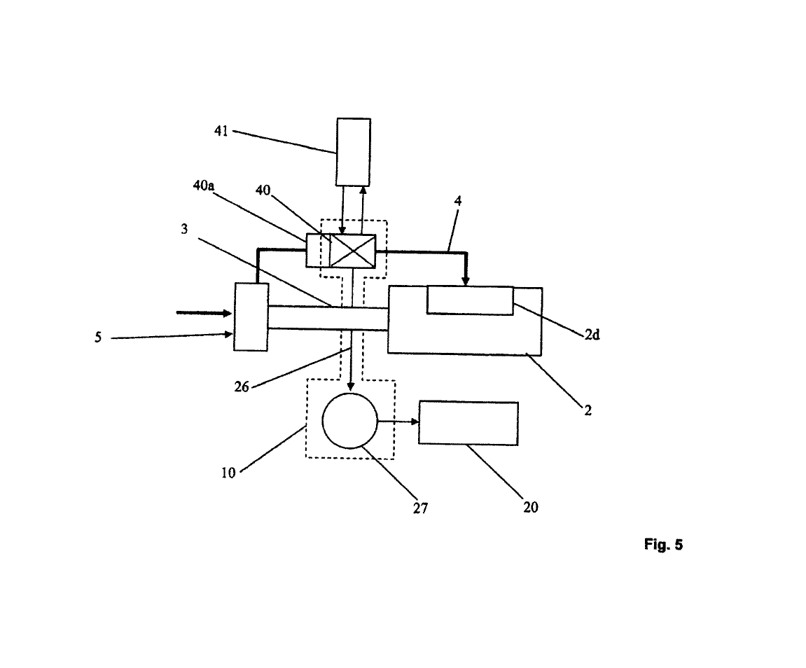

In another embodiment of the present invention, which is shown in FIG. 5, the thermal machine 2 is a combined cycle power unit including a steam turbine and a steam condenser 2d, which is cooled, at least partially by the second fluid in the ventilation circuit 4.

The power plant 1 further includes a water recovery device 10 connected with the inlet duct 3 and the ventilation circuit 4 for condensing and collecting water from the first and the second fluid, the water recovery device being associated with a first heat exchanger 30 and a second heat exchanger 40 thermally connected with the inlet duct 3 and the ventilation circuit 4, respectively, for cooling the first and the second fluid beyond the dew point thereof. The first and/or second heat exchangers are, for example, constituted by air coils.

The first heat exchanger 30 assures, particularly in hot environments or seasons, that the combustive first fluid is cooled in order to maximize the power generated by the thermal machine 2.

In addition, the combustive fluid to be supplied to the thermal machine 2 needs to be filtered from impurities to avoid damaging or excessive wearing of the components, in particular rotary components, of the thermal machine 2.

In order to assure the desired quality of the combustive fluid the power plant 1 further includes, on a suction side of inlet duct 3, an inlet air treatment system 5 including the first heat exchanger 30 and one or more filtering modules 6, 7, respectively upstream and downstream the first heat exchanger 30, for removing solid impurities and/or other impurities. The inlet air treatment system 5 can be arranged in a plurality of configurations, depending on the specific requirements of the power plant 1. For example, the inlet air treatment system 5 may include a weather hood, or a plurality of weather hoods, for protecting the inlet air treatment system 5 from weather agents. In some embodiments, the upstream filtering modules 6 of the inlet air treatment system 5 comprise HEPA and/or ULPA filters for removing, respectively, bacteria and viruses from the humid air entering the first heat exchanger 30.

Optionally, filtration may be requested also in the ventilation circuit 4. In such a cases (FIGS. 1, 4 and 5) an upstream filtering modules 40a, comprising HEPA and/or ULPA filters, are provided upstream the heat exchanger 40.

For the chilling of the first and second heat exchanger 30, 40, the power plant 1 comprises cold sources 31, 41 respectively connected to the first and second heat exchanger 30, 40 for respectively extracting heat from the first and the second fluid.

In the embodiments in FIGS. 1-5, the cold source 31 is constituted by an absorption refrigeration cycle, which is connected to a heat recovery vapour generator 35 having a plurality of tubes thermally contacting the exhaust stack 12.

The tubes of heat recovery vapour generator 35 extract the thermal energy from the exhaust gas of the gas turbine, for use in the absorption refrigeration cycle 31. The absorption refrigeration cycle which constitutes the cold source 31 in the embodiments in FIG. 1-5 is well-known in the art and for this reason is not described in detail. For example, in an embodiment of the present invention, absorption refrigeration cycle is of the water-ammonia type.

In the embodiments in FIGS. 1-5, the cold source 41 is of the mechanical type, including a compression stage (not represented), which is well-known in the art and for this reason is not described in more detail.

In general, for the scopes of the present invention, cold sources 31, 41 could be of any type, including also the evaporative type, provided that the correct amount of cooling power is generated for the heat exchangers 30, 40, respectively. The type of could source 31, 41 is chosen considering the specifications and requirements of the power plant 1. For example, it has to be considered that normally the amount of water that can be condensed from one of the first and second fluid is lower than the amount of water to be condensed from the other fluid. For example, when the thermal machine is a gas turbine, the amount of water that can be condensed from the second fluid is lower than the amount of water to be condensed from the first fluid. Therefore in such cases, when lower quantities of condensed water are needed, only the second heat exchanger 40 is provided on the ventilation circuit 4 of the power plant 1.

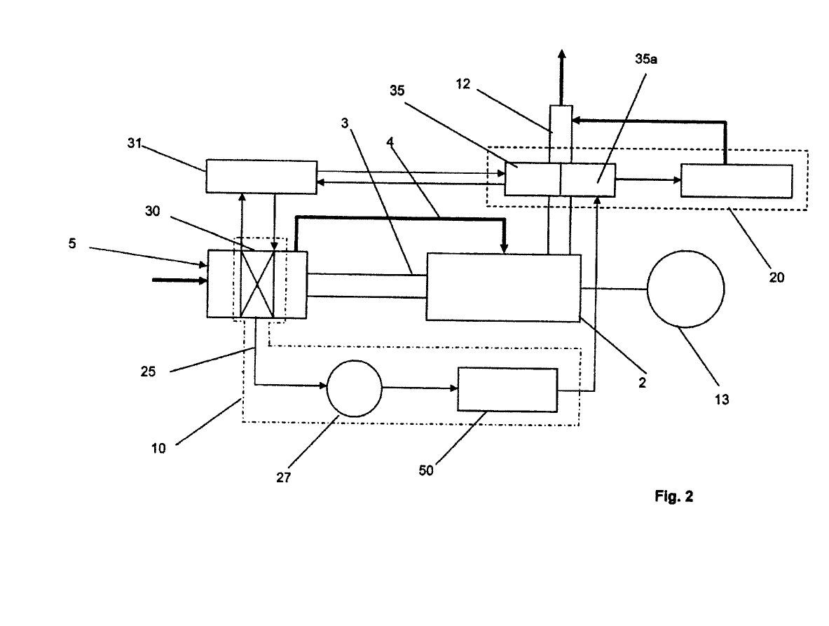

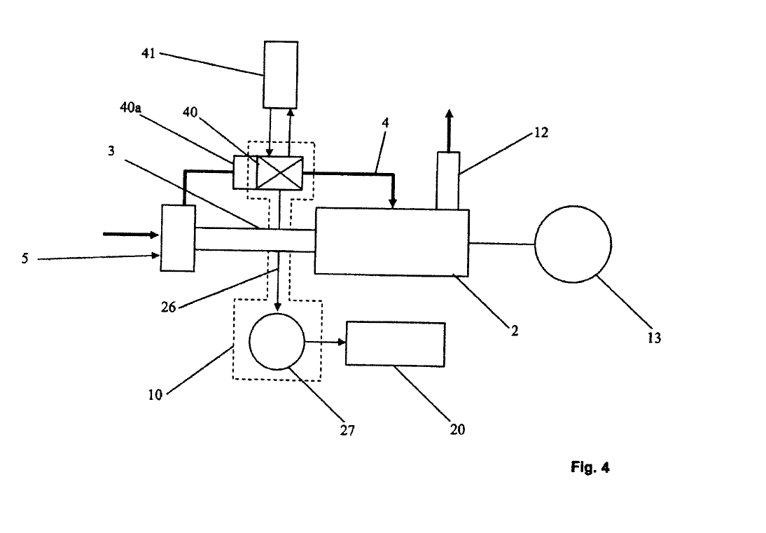

In embodiments like that in FIG. 1, where both the first and the second heat exchangers 30, 40 are present, the ventilation circuit 4 comprises an inlet section which is open to the atmosphere for receiving humid air. In embodiments like that in FIGS. 2 and 3, where only the first heat exchanger 30 is present, the inlet section of ventilation circuit 4 is directly connected with the inlet duct 3 or the inlet air treatment system 5, downstream the first heat exchanger 30, for receiving the same dry air which flows in the inlet duct towards the thermal machine 2. In embodiments like that in FIG. 4, where only the second heat exchanger 40 is present, the inlet section of ventilation circuit 4 is directly connected with the inlet duct 3 or the inlet air treatment system 5, for receiving the same humid air which flows in the inlet duct towards the thermal machine 2.

When dew point conditions are reached in the first and second heat exchanger 30, 40, water is separated from the first and second fluid, respectively, and collected at the bottom of the first and second heat exchanger 30, 40. The water recovery device 20 includes connecting means 25, 26, 27 for delivering the condensed water recovered from the first and/or the second fluid to a water using device 20. Connecting means 25, 26, 27 include a feed pump 27 and pipes 25, 26 for respectively providing water from the first and second heat exchanger 30, 40 to the pump 27. The condensed water is delivered to the water user device 20 through the pump 27. Optionally, between the pump 27 and the water user device 20 a water treatment device 50 is provided for improving the quality of the water which enters the water user device 20.

In the embodiments in FIGS. 1-5, the water using device 20 is of the open-cycle type, i.e. the condensed water recovered from the first and/or the second fluid is delivered to a using device which is not re-used within the thermal machine 2, but is sent to other using devices of the power plant 1.

In some embodiments the water using device 20 includes heating means for producing steam from the water separated and collected by the water recovery device 10. For example, in the embodiments in FIGS. 2 and 3, the water using device 20 includes heating means for producing steam which are constituted by an heat exchanger 35a provided along the exhaust of the thermal machine 2, downstream heat recovery vapour generator 35. Alternatively, in other (not shown) embodiment such heating means is constituted by a boiler. The steam produced by such heating means is delivered to a steam expander 51 for producing energy. After expansion, steam exiting the steam expander 51 is then delivered to the exhaust stack 12 of the thermal machine 2. Steam expander 51 is connected to a second electric power generator 52.

According to another (not shown) embodiment of the present invention, the water using device 20 includes a water treatment unit for producing drinkable water.

According to a further (not shown) embodiment of the present invention the water using device 20 includes a combined cycle power unit.

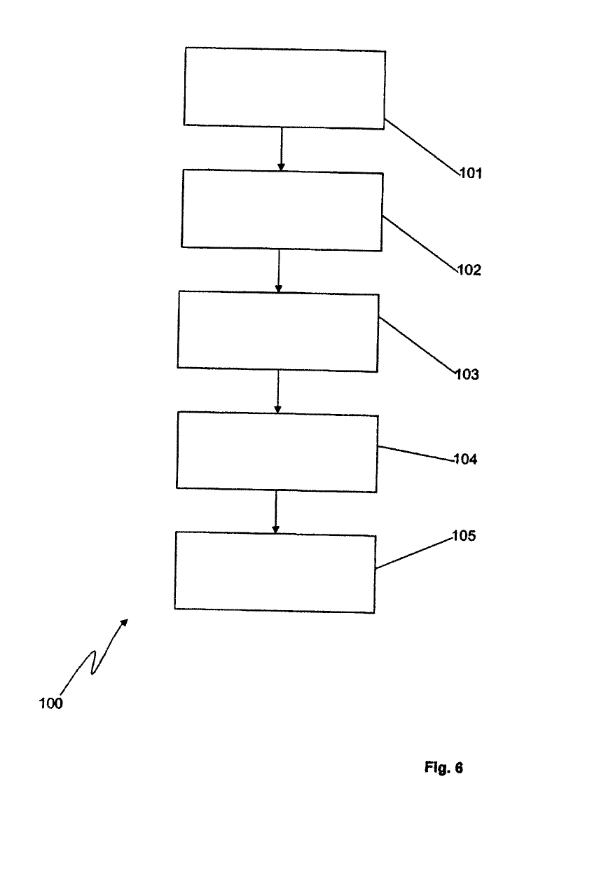

In a third embodiment of the present invention, diagrammatically represented in FIG. 6, a method 100 for improving efficiency in the power plant 1 comprises five main steps 101-105.

In a first step 101 of the method 100, a first and a second heat exchangers 30, 40 are thermally connected with an inlet duct 3 of a thermal machine 2 of the power plant 1 and/or the ventilation circuit 4 of the thermal machine 2.

In a second step 102 of the method 100, the heat exchanger 30, 40 are operated to cool a first fluid flowing in the inlet duct 3 and/or a second fluid flowing in the ventilation circuit 4, the first and/or the second fluid including water therein.

In a third step 103 of the method 100, are brought beyond the dew point thereof in order to condensate the water therein.

In a fourth step 104 of the method 100, the water condensed from the first and/or the second fluid is collected.

In a fifth step 105 of the method 100, the condensed recovered water is used to improve the efficiency of the power plant.

In respective embodiment of the method 100, the fifth step 105 consists in delivering the condensed water to a combined cycle power unit and/or to a water treatment unit for producing drinkable water and/or to heating means for producing steam.

The present invention allows accomplishing the object and advantages cited above, by providing a water recovery device which allows generating the required flow of condensed water for any configuration or working condition of the power plant. In addition, the present invention allows reaching further advantages. In particular, the method above described can be used in refurbishing an existing power plant by including therein a water recovery device according to the present invention.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other example are intended to be within the scope of the claims if they have structural elements that do not differ from the literal language of the claims, or if they include equivalent structural elements with insubstantial differences from the literal languages of the claims.

What is claimed is:

1. A power plant, comprising:
a thermal machine;
an inlet duct for delivering a combustive first fluid in the thermal machine;
a ventilation circuit for delivering a cooling second fluid to the thermal machine, wherein the first and/or the second fluid comprises water therein; and
a water recovery device connected with the inlet duct and/or the ventilation circuit, configured to condense and to collect the water from the first and/or the second fluid, and comprises:
at least one heat exchanger thermally connected with the inlet duct and/or the ventilation circuit for cooling the first and/or the second fluid beyond the dew point; and
a connector for delivering the water condensed from the first and/or the second fluid to a water using device.

2. The power plant according to claim 1, wherein the water recovery device is thermally connected with the ventilation circuit for separating and collecting the water from the second fluid.

3. The power plant according to claim 1, wherein the water using device is of an open-cycle type.

4. The power plant according to claim 2, wherein the water using device comprises:
at least one heating element for producing steam from the water separated and collected by the water recovery device; and
a steam expander for producing energy from the steam.

5. The power plant according to claim 1, wherein the water using device comprises a water treatment unit for producing drinkable water.

6. The power plant according to claim 2, wherein the water using device comprises a combined cycle power unit.

7. The power plant according to claim 1, wherein the heat exchanger is chilled by an absorption refrigeration cycle.

8. A water recovery device for a power plant, wherein the power plant comprises a thermal machine, an inlet duct for delivering a combustive first fluid in the thermal machine, and a ventilation circuit for delivering a cooling second fluid to the thermal machine, wherein the water recovery device is connected with the thermal machine for condensing water from the and/or the second fluid, the water recovery device comprising:
at least one heat exchanger thermally connected with the inlet duct and/or the ventilation circuit for cooling the first and/or the second fluid beyond the dew point; and
a connector for delivering the water condensed from the first and/or the second fluid to a water using device.

9. A method for improving efficiency in a power plant, wherein the power plant comprises a thermal machine, the method comprising:
thermally connecting at least one heat exchanger with an inlet duct of the thermal machine and/or a ventilation circuit of the thermal machine;
operating the heat exchanger to cool a first fluid flowing in the inlet duct and/or a second fluid flowing in the ventilation circuit, the first and/or the second fluid comprising water;
bringing the first and/or the second fluid beyond a dew point in order to condensate the water;
collecting the water condensed from the first and/or the second fluid; and
using the condensed water to improve the efficiency of the power plant.

10. The method according to claim 9, wherein using the condensed water comprises delivering the condensed water to a combined cycle power unit, and/or to a water treatment unit for producing drinkable water, and/or to at least one heating element for producing steam.

11. The power plant according to claim 4, wherein the water recovery device is thermally connected with the ventilation circuit for separating and collecting the water from the second fluid.

12. The power plant according to claim 5, wherein the water recovery device is thermally connected with the ventilation circuit for separating and collecting the water from the second fluid.

13. The power plant according to claim 7, wherein the water recovery device is thermally connected with the ventilation circuit for separating and collecting the water from the second fluid.
